(19) United States
(12) Patent Application Publication
(10) Pub. No.: US 2026/0244714 A1
(43) Pub. Date: Aug. 20, 2026

(54) SAMPLE DATA CATEGORY IDENTIFICATION METHOD, IDENTIFICATION MODEL AND TRAINING METHOD THEREFOR

(71) Applicant: Beijing Zitiao Network Technology Co., Ltd., Haidian District, Beijing (CN)

(72) Inventors: Jingna SUN, Beijing (CN); Yingfan TAO, Beijing (CN); Hao YANG, Beijing (CN); Li CHEN, Beijing (CN); Xu WANG, Beijing (CN); Kang DU, Beijing (CN)

(21) Appl. No.: 19/160,960

(22) PCT Filed: Mar. 1, 2024
(86) PCT No.: PCT/CN2024/079578

§ 371 Date: Aug. 29, 2025

(30) Foreign Application Priority Data
Mar. 2, 2023 (CN) 202310226153.7

(51) Int. Cl. G06F 18/2413; G06N 20/20

(52) U.S. Cl. CPC G06F 18/2413; G06N 20/20

(57) ABSTRACT

The present disclosure relates to a method for identifying a sample data category, an identification model and a method for training it. The identification method comprises: inputting a sample to an identification model obtained by ensembling a plurality of sub-models including a plurality of branch models that are obtained by training full data of a training set through a preset loss function. Each branch model focuses on a focused category subset in the full data. The method further comprises identifying the category to which the input sample belongs according to the output of the identification model. Different loss functions are set through a plurality of branches respectively focusing on different category subsets in the full-scale training set, and the plurality of branches are finally ensembled to obtain an identification model with high identification capability for all data categories of the full data.

### CROSS REFERENCE TO RELATED APPLICATIONS

The present application is based on and claims priority from the CN application No. 202310226153.7, filed on Mar. 2, 2023, the disclosure of which is incorporated herein by reference in its entirety.

### TECHNICAL FIELD

The present disclosure relates to the technical field of data classification, and in particular to an identification method and an identification model for sample data category and a training method thereof.

### BACKGROUND ART

In the process of identifying the category of sample data through an identification model, most machine learning models are trained by a training set in a certain distribution mode. However, the distribution mode of the training set can affect the training of the identification model, and the identification model with a category having a large number of samples in the training set has a corresponding better identification capability.

In some common cases, in the training set, sample data of minority categories occupy a larger portion and sample data of majority categories occupy a less portion. Such a data distribution would result in deviation in model training, such that the model is biased to identification of the majority sample categories, and the identification accuracy of the minority sample categories is ignored.

### DISCLOSURE OF THE INVENTION

In view of this, an embodiment of the present disclosure provides an identification method, an identification model, and a training method for a training set, so as to solve a problem in the related art in a poor identification accuracy of the identification model resulting from the way to train the identification model due to uneven distribution of data of the training set.

According to a first aspect, an embodiment of the present disclosure provides a method for identifying a sample data category, the method comprising: inputting an input sample to be identified to an identification model, wherein the plurality of identification models are obtained by ensembling a plurality of sub-models, the plurality of sub-models including a plurality of branch models that are obtained by training full data of a training set through a preset loss function, each branch model focusing on a focused category subset corresponding to the each branch model in the full data, and the focused category subset being at least one category in a plurality of categories in the full data; and identifying the category to which the input sample belongs according to the output of the identification model.

With reference to the first aspect, in a first implementation of the first aspect, before inputting the input sample to be identified to the trained identification model, the method further comprises: dividing the full data into focused category subsets corresponding to the plurality of branch models according to a number of the plurality of branch models, wherein the plurality of branch models correspond to the focused category subsets on a one-to-one basis, and the number of samples of each focused category subset is within a preset range of sample number; training the plurality of branch models according to the full data, wherein the branch models are trained through a preset loss function in the training process; and ensembling the plurality of branch models to obtain an identification model.

With reference to the first aspect, in a second implementation of the first aspect, the plurality of sub-models further include: an inverse distribution model, the method further comprising: training the inverse distribution model through a preset loss function based on the full data, wherein the preset loss function is determined through an inverse distribution coefficient; and ensembling the inverse distribution model and a plurality of branch models to obtain the identification model.

With reference to the first aspect, in a third implementation of the first aspect, the training, based on the full data, of the inverse distribution model through a preset loss function comprises: determining a boundary distance between the category of the target sample label and the target category according to a logarithm of a ratio of the number of samples of the target category to the number of samples of the target sample label and the inverse distribution coefficient; and adjusting an interval boundary of the category identified by the inverse distribution model according to the boundary distance.

With reference to the first aspect, in a fourth implementation of the first aspect, the plurality of sub-models are trained by a preset loss function in the following manner: creating a loss function based on classifier output data corresponding to a sub-model in a target sample label and first adjusting data and classifier output data corresponding to the sub-model in a target category and second adjusting data, wherein the target sample label is one of a plurality of sample labels of an input sample, and the target category is one of a plurality of categories in the full data; and training the sub-model through the loss function until the model converges.

With reference to the fourth implementation of the first aspect, in a fifth implementation of the first aspect, before creating a loss function based on classifier output data corresponding to a sub-model in a target sample label and first adjusting data and classifier output data corresponding to the sub-model in a target category and second adjusting data, the method further comprises: calculating first adjusting data according to a first adjusting function and classifier output data corresponding to the target sample label; calculating second adjusting data according to a second adjusting function and classifier output data corresponding to the target category; wherein the first adjusting function and the second adjusting function are the same function.

With reference to the fourth implementation of the first aspect, in a sixth implementation of the first aspect, the training of the sub-model through a preset loss function comprises: determining a boundary distance between the category of the target sample label and the target category according to a difference between the first adjusting data and the second adjusting data; and adjusting an interval boundary of the category identified by the sub-model according to the boundary distance.

With reference to the sixth implementation of the first aspect, in a seventh implementation of the first aspect, determining a boundary distance between the category of the target sample label and the target category according to a difference between the first adjusting data and the second adjusting data comprises at least one of the following: in response to the target category and the target sample label both belonging to a focused category subset of the branch model, according to a ratio of the sample number of the target category to the sample number of the sample label and taking a logarithm thereof, determining the boundary distance; in response to the target category not belonging to a focused category subset of the branch model, the target sample label belonging to the focused category subset, according to a logarithm of a ratio of a maximum value of a sample number of each category in the training set to a sample number of the target sample label, determining the boundary distance, wherein the boundary distance is greater than 0; in response to the target category belonging to a focused category subset of the branch model, the target sample label not belonging to the focused category subset, according to a logarithm of a ratio of a sample number of the target category to a maximum value of sample number of each category in the training set, determining the boundary distance, wherein the boundary distance is less than 0; in response to neither the target category nor the target sample label belonging to a focused category subset of the branch model, determining the boundary distance is 0.

With reference to the sixth implementation of the first aspect, in an eighth implementation of the first aspect, adjusting an interval boundary of the category identified by the sub-model according to the boundary distance comprises: adjusting weights of categories corresponding to the target category and the target sample category according to the boundary distance so as to adjust the interval boundary of the category identified by the sub-model.

With reference to the eighth implementation of the first aspect, in a ninth implementation of the first aspect, after adjusting the weights of the categories corresponding to the target category and the target sample label according to the boundary distance to train the category interval of the focused category subset, the method further comprises: in an iteration process of the branch model, adjusting classifier parameters of the branch model according to adjusted weights of categories corresponding to the target category and the target sample label, wherein the weights are the classifier parameters of the branch model, and the adjusted weights enable the classifier to more focus on the focused category subset; performing iterative training according to the adjusted classifier parameters; in response to satisfying a preset iteration termination condition, completing the training of the branch model; and in response to not satisfying the preset iteration termination condition, continuing to select a target category and a target sample label to continue training of the branch model.

According to a second aspect, an embodiment of the present disclosure provides a method for training an identification model of a sample data category, the method comprising: training full data of a training set by utilizing a preset loss function to obtain a plurality of branch models, wherein each branch model focuses on a focused category subset corresponding to each branch model in the full data, and the focused category subset is at least one category in a plurality of categories in the full data; and ensembling a plurality of sub-models comprising the plurality of branch models to obtain an identification model, wherein the identification model is used for identifying an input sample and determining the category of the input sample.

According to a third aspect, an embodiment of the present disclosure provides an identification model for a sample data category, comprising: a plurality of sub-models, and an ensembling module; the plurality of sub-models comprise a plurality of branch models, the branch models are obtained by training full data of a training set through a preset loss function, each branch model focuses on a focused category subset corresponding to each branch model in the full data, and the focused category subset is at least one category in a plurality of categories in the training set; the ensembling module is connected with outputs of the plurality of sub-models and is used for ensembling the output data of the sub-models to obtain a final identification result.

According to a fourth aspect, an embodiment of the present disclosure provides a computer-readable storage medium for storing a program that performs the method for identifying a sample data category or the method for training a model for identifying a sample data category as described in any implementation of the first aspect.

According to a fifth aspect, an embodiment of the present disclosure provides a computer terminal comprising one or more processors and a memory for storing one or more programs, which, when executed by the one or more processors, cause the one or more processors to perform the method for identifying a sample data category or the method for training a model for identifying a sample data category as described in any implementation of the first aspect.

According to a sixth aspect, an embodiment of the present disclosure provides a computer program comprising: instructions, which, when executed by a processor, cause the processor to perform the method for identifying a sample data category or the method for training a model for identifying a sample data category as described in any implementation of the first aspect.

### DESCRIPTION OF THE DRAWINGS

The features and advantages of the present disclosure will be more clearly understood by reference to the accompanying drawings, which are schematic and are not to be construed as limiting the disclosure in any way, and in which:

FIG. 1 illustrates a flow chart of a method of identifying a sample data category according to an embodiment of the present disclosure;

FIG. 2 illustrates a flow chart of a method of identifying a sample data category according to an embodiment of the present disclosure;

FIG. 3 shows a schematic diagram of a sample data category identification network structure according to an embodiment of the present disclosure;

FIG. 4 illustrates a flow chart of a method of identifying a sample data category according to an embodiment of the present disclosure;

FIG. 5 illustrates a flow chart of a method of identifying a sample data category according to an embodiment of the present disclosure;

FIG. 6(a) illustrates a schematic diagram of category weight adjustment according to a boundary distance in a case where a target sample label belongs to a focused category subset according to an embodiment of the present disclosure;

FIG. 6(b) illustrates a schematic diagram of category weight adjustment according to a boundary distance in a case where a target sample label does not belong to a focused category subset according to an embodiment of the present disclosure;

FIG. 7 illustrates a flow chart of a method for identifying a sample data category according to an embodiment of the present disclosure;

FIG. 8 illustrates a flow chart of a method for training a model for identifying a sample data category according to an embodiment of the present disclosure;

FIG. 9 illustrates a schematic diagram of an identification model for sample data category according to an embodiment of the present disclosure; and

FIG. 10 illustrates a schematic diagram of a computer terminal according to an embodiment of the disclosure.

### DETAILED DESCRIPTION

To make the objects, technical solutions and advantages of the embodiments of the present disclosure more apparent, the technical solutions in the embodiments of the present disclosure will be described clearly and completely with reference to the drawings in the embodiments of the present disclosure, and it is obvious that the described embodiments are some, but not all embodiments of the present disclosure. All other embodiments obtainable to those skilled in the art from the embodiments disclosed herein without any inventive labor are intended to be within the scope of the present disclosure.

As mentioned above, in a training set, sample data of minority categories occupy a larger portion and sample data of majority categories occupy a less portion, which results in a deviation in model training, such that the model is biased to identification of the majority sample categories, and the identification accuracy of the minority sample categories is ignored.

In this case, when an identification model is trained, the model would have a preference in identification capability, which would result in a low accuracy of identification for the identification model. In this regard, there is a need to provide better solutions.

The training set may be a dataset having a certain distribution pattern. In general, natural datasets are not uniformly distributed over multiple categories, and long-tailed data with a long-tailed distribution are more common, i.e., a few categories have a large number of samples, and such categories are referred to as head categories, while a majority of categories have a small number of samples, ad such categories are referred to as tail categories.

Generally, the number of samples in the head categories differs from the number of samples in the tail categories by several times or even several tens or hundreds of times. Due to the great difference in sample number between different categories, in a normal model training, long-tailed data can enable the model to have good identification capability for the head categories and poor identification capability for the tail categories, and even data samples of the tail categories cannot be identified effectively.

In the related art, a plurality of methods are used for relieving the problem of identifying long-tailed data and improving accuracy rate of identification of a uniform test set. The main issue is to train an identification model in a certain mode during training of the identification model, so that the identification model has good identification capability in all categories of long-tailed data, specifically comprising the following three categories.

The first category is category rebalancing, which mainly includes two aspects, one being to under-sample multiple sample categories or over-sample few sample categories, and the other being to weight different categories or samples.

The second category is a method of splitting the representation model and the category model to avoid the impact of rebalancing on the representation model.

The third category is an ensembling method, in which different branch models are used, results from the different branch models are fused to improve the identification effect of long-tailed data; the specific method is that different local data are inputted into different branches and then fused, so that the imbalance degree can be reduced, but the branches trained by different local data are in different feature spaces, and it is a difficult problem to fuse the different feature spaces.

In view of the above, the present embodiment provides a method for identifying a sample data category, which mainly adopts a multi-branch model ensembling manner, and further improves the fused effect by enriching the diversity of the focused category subsets of different branch models. Input data of each branch model is full data of the training set, so that the feature space of each branch can be kept consistent to facilitate subsequent fusion; by a design of a loss function, different branch models focus on different category subsets, and in this way, the imbalance degree of the data in each branch model is reduced, and the identification effect of each branch model on the focused category subsets is improved; finally, different branch models are fused to enable the identification model to have a good identification effect on all categories of the training set, thereby integrally improving the identification effect.

In some embodiments, the training set is first divided into a plurality of category subsets according to the number of the branch models, and then the plurality of category subsets are assigned to the respective branch models as focused category subsets corresponding to the branch models. There is no intersection between the focused category subsets of the plurality of branch models, and the focused category subsets corresponding to all branch models jointly form all categories of the training set. In this way, all the categories of the training set can be effectively trained to the greatest extent, and the finally obtained identification model can also have good identification capability on all the categories of the training set.

A loss function is created based on an adjusting function, the loss function being determined based on a ratio of output data of the input samples and total output data for each category. Depending on whether the input samples and the different categories belong to the focused category subsets of the branch model, different adjusting modes are set based on the adjusting function to train the focused category subsets of the branch model, namely, to adjust focusing degree of identification of different categories of the branch model.

Output data of the sample are created based on the adjusting function and a sample label of an input sample, i.e. classifier output data corresponding to a target sample label, and total output data of each category are created based on the adjusting function and output data of the classifier corresponding to each category. Thus, the loss function has an ability to adjust degrees of focusing on different categories within and outside the focused category subset depending on the number of samples.

By deforming the loss function, a deviation distance of a boundary surface between a category corresponding to the target sample label and a certain target category, that is, a boundary distance, can be obtained. Based on the boundary distance, weights of the category corresponding to the target sample label and the target category are adjusted so as to adjust a boundary between the categories. Hence, identification of the categories within the corresponding focused category subset that are more focused by the branch model is optimized.

The training of the branch model requires the input of the full data of the training set, and by utilizing the created loss function, an identification capability of the branch model for categories within the focused category subset can be improved. Then, through ensembling of a plurality of branch models, an identification model having a high identification capability for each category is obtained.

In addition, in a case where neither the category corresponding to the target sample label nor the target category belongs to the focused category subset of the branch model, the branch model would generate identification deviation in categories outside the focused category subset due to imbalanced sample number of the categories. In order to weaken the deviation, the embodiment further provides an inverse distribution model, which is trained and optimized through full data of the training set.

The method for identifying sample data category and the method for training an identification model of the sample data category provided by the specification can be applied to a computer system or a processing module with data operation and data communication functions in the computer system. The method for training an identification model of the sample data category provided in the specification can be applied to an electronic device carried on a computer system.

Such an electronic device can include a notebook computer, a desktop computer, a smart mobile phone, a smart wearable device (virtual reality glasses, a smart wrist-watch etc.), a panel computer etc. Of course, the method for training an identification model of the sample data category provided by the specification may also be applied to an application program running on the electronic device. For example, the method for identifying sample data category and the method for training an identification model of the sample data category may be applied to a browser having an instant messaging function, and may also be applied to instant messaging software.

In some embodiments, the training set may be an image dataset, wherein the identification model is an image identification model, and one image may be one data sample. The plurality of image categories in the training set can be divided in advance, and the category to which a certain image belongs can be effectively identified by the method for identifying sample data category according to the embodiment.

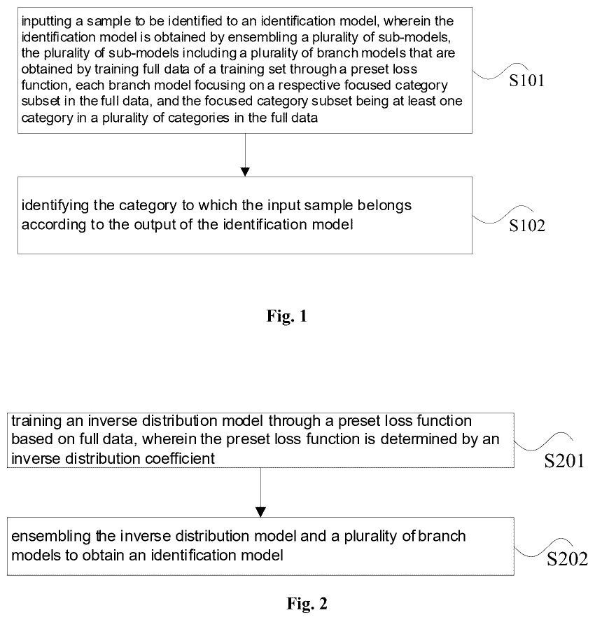

FIG. 1 illustrates a flow chart of a method for identifying a sample data category according to an embodiment of the present disclosure. As shown in FIG. 1, according to a first aspect, an embodiment of the present disclosure provides a method for identifying a sample data category, the method comprising the following steps:
Step S101, inputting an input sample to be identified into an identification model, wherein the identification model is obtained by ensembling a plurality of sub-models that include a plurality of branch models that are obtained by training full data of a training set using a preset loss function, each branch model focusing on a corresponding focused category subset in the full data, and the focused category subset being at least one category in a plurality of categories in the full data; and
Step S102, according to an output of the identification model, identifying the category to which the input sample belongs.

The branch model that is obtained by training the full data of the training set using a preset loss function has a high identification capability for focused category subsets, and an identification model obtained by ensembling a plurality of branch models has a good identification capability for all categories of the training set. The identification model is used to identify an input sample, resulting in a higher identification accuracy.

The number of the branch models is two or more. In some embodiments, before inputting the input sample to be identified into the trained identification model, the method further comprises: based on the number of the branch models, dividing full data of the training set into focused category subsets corresponding to a plurality of branch models, wherein the branch models correspond to the focused category subsets on a one-to-one basis, and the number of samples of each focused category subset is within a preset range of sample number, so that the number of samples contained in each focused category subset is approximately the same.

It should be noted that, in some embodiments, the focused category subsets corresponding to the respective branch models do not intersect, and a union obtained from the focused category subsets corresponding to the plurality of branch models constitutes full data of the training set.

When the full data of the training set are divided, all categories can be sorted according to the sample number of each category, and a plurality of categories that are close in the sequence may be classified into the same focused category subset. Therefore, it is ensured the number of the samples of the plurality of categories classified in the same focused category subset is uniform as much as possible, and it is avoided the number of the samples of a plurality of categories classified in the same focused category subset differs greatly, resulting in uneven distribution, so that the branch models trained by the focused category subsets have differences in identification performance for different categories.

In some embodiments, the full data are divided in this embodiment. When focused category subsets are divided based on the number of branch models, not only the number of samples of the focused category subsets but also the distribution of the number of samples of the categories in the focused category subset are considered. For example, when there are two branch models, and the full data of the training set involve 10 categories, the first 3 categories in sequence are divided into a subset and the last 7 in sequence categories are divided into another subset according to the number of samples in each category. Thus, the imbalance degree of data in each subset can be significantly reduced, which facilitates targeted identification optimization of the branch model for each subset.

Then, a plurality of branch models are trained according to the full data of the training set, and in the training process, the branch models are trained using a preset loss function so as to enable the branch models to focus on the corresponding focused category subsets; after the training of the plurality of branch models is finished, the plurality of branch models are ensembled to obtain an identification model.

Said steps adopt a method of ensembling a plurality of branch models, and through the diversity of the focused category subsets of the plurality of different branch models, an identification accuracy of the fused identification model is improved. The input data of each branch model is the full data of the training set, and the design of a loss function enables different branch models to focus on different focused category subsets.

By dividing the full data of the training set into focused category subsets corresponding to the plurality of branch models, compared with the distribution imbalance degree of the full data of the training set, the distribution imbalance degree of the data in the focused category subsets corresponding to each branch model is reduced, so that the identification effect of the branch models in the focused category subsets is improved, and finally, the identification effect is integrally improved by fusing different branches.

Due to the characteristic of uneven data distribution of the training set, when an identification model is trained in the related art, the identification model is more biased to the categories with more number of samples, such that the identification accuracy of the whole identification model is low. Compared with the mode in the related art that a plurality of branch models are adopted and different local data are inputted into different branch models for training and fusing, the embodiment of the present disclosure inputs full data into a branch model, and designs a loss function to enable different branch models to focus on different category subsets, so that the imbalance degree of data in the focused category subsets is reduced, the identification effect of the corresponding category subsets is improved, and meanwhile, a better fusion effect and a better identification performance can be achieved.

The mode of inputting full data into the branch models enables the respective branch models to be located in the same feature space, which facilitates subsequent ensembling and fusion of a plurality of branch models and improves the fusion effect. Compared with the case that the branch models are in different feature spaces, the identification results of the respective branch models in the same feature space on the respective focused category subsets can be more effectively fused in the identification model.

By presetting a respective loss function, each branch model can focus on the focused category subset corresponding to the branch model itself, so that the branch model has a better identification capability on categories in the focused category subset, and finally, the identification model obtained through ensembling and fusion has better identification capability on all data categories.

The full data of the training set is divided into a plurality of focused category subsets corresponding to a plurality of branch models, where the focused category subsets are obtained by dividing the number of the branch models according to the categories and the number of samples in the training set. In the process of training a branch model, the branch model may have a better identification capability for a plurality of categories in the focused category subset according to the setting of the loss function. Thus, a set of the plurality of categories corresponding to the branch model may be referred to as a focused category subset, and it may be said that the branch model focuses on a plurality of categories in the focused category subset.

Because the branch models are all trained by the full data of the training set, in the process of training the branch models, adaptive adjustments can be performed on the boundary intervals of respective categories in the training set based on setting of the loss function.

In some embodiments, the adjustment of the boundary interval of each category in the training set may include adjusting boundary category intervals of the focused category subsets, that is, a boundary interval of a starting category and a boundary interval of an ending category constituting the focused category subsets. The boundary intervals of different categories within the focused category subsets may also be adjusted. Further, the boundary intervals of different categories outside the focused category subsets may be adjusted.

The full data comprise a plurality of categories of the training set and samples of each category, each branch model corresponds to one focused category subset, and the number of samples of each focused category subset is within a preset range of sample number.

The number of samples of the focused category subset of each branch model is within the preset range of sample number, so that each branch model can focus on a proper number of samples during training, a final training result and identification accuracy of different branch models can be guaranteed to be basically consistent to facilitate subsequent ensembling, and the overall identification accuracy of the ensembled identification model is guaranteed.

The full data of the training set is inputted into the branch models for training so as to ensure feature spaces for different branch models are consistent to facilitate fusing of branch models after training has been finished, thereby further improving the identification effect of the sample data of all categories of the training set.

In the training process, the branch model is subjected to targeted optimization within the category range of focused category subset based on a preset loss function that is set to enable a classifier of the branch model to pay more attention to the corresponding focused category subset. Specific contents of the loss function will be explained in the following.

The boundary interval of the focused category subset can be optimized through the loss function, and then the classifier parameters of the branch model are updated, so that the classifier of the branch model has better identification capability on the categories of the focused category subset.

The focused category subset as used here is at least one category, typically a plurality of categories, of a plurality of categories in the training set.

An accurate and efficient loss function is set for the branch models, so that after the full data are inputted into different branch models, the branch models can still ensure to have a better identification capability for data categories within the focused category subsets. After the training of the plurality of branch models is finished, the plurality of branch models are ensembled to obtain an identification model. Since the plurality of branch models are located in a consistent feature space and have a better fusing effect at the time of the ensembling, after the plurality of branch models are ensembled, they would have a better identification capability for all data categories in the training set.

FIG. 2 illustrates a flow chart of a method for identifying a sample data category according to an embodiment of the present disclosure. As shown in FIG. 2, the plurality of sub-models further include: an inverse distribution model, the method further comprising:
Step S201, training the inverse distribution model through a preset loss function based on full data, wherein the preset loss function is determined through an inverse distribution coefficient; and
Step S202, ensembling the inverse distribution model and a plurality of branch models to obtain an identification model.

Although the plurality of branch models respectively focus on different category subsets, in the optimization process, data outside the focused category subset corresponding to each branch model also participate in training of the branch model, which may cause identification deviation generated by the branch model in categories outside the focused category subset.

In order to solve this problem, the embodiment of the present disclosure provides an inverse distribution model, determines a preset loss function through an inverse distribution coefficient, and trains the inverse distribution model by using full data of the training set, so as to weaken the identification deviation generated by each branch model in the categories outside the corresponding focused category subset, thereby further improving the identification accuracy of the ensembled identification model.

It should be noted that, it can be understood that the focused category subset corresponding to the inverse distribution model includes all categories in the training set.

In some embodiments, a sub-model of the identification model includes two branch models, and one inverse distribution model.

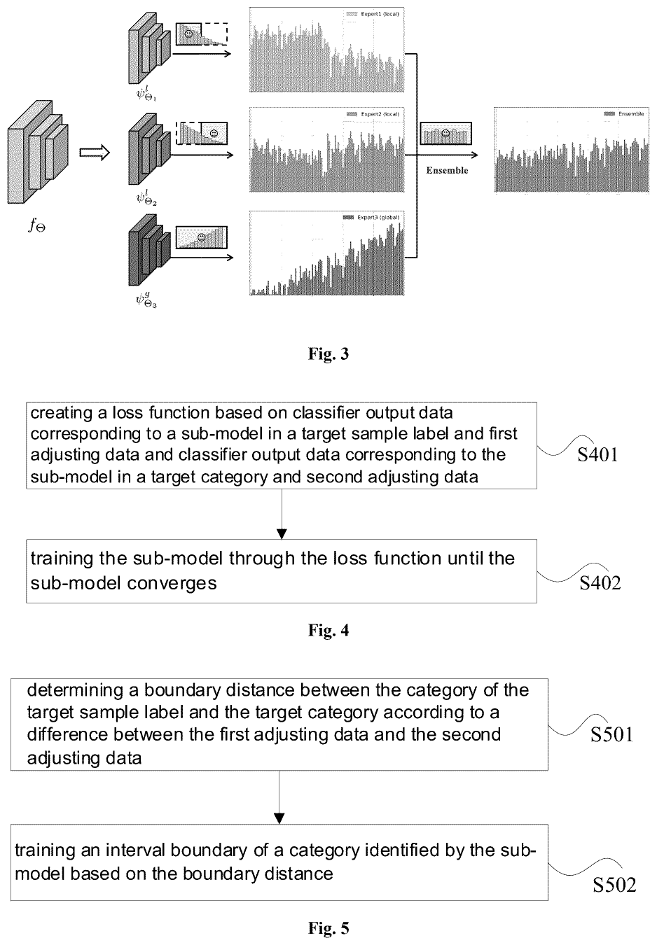

FIG. 3 shows a schematic diagram of a sample data category identification model network structure according to an embodiment of the present disclosure. The entire network structure is as shown in FIG. 3. First, f_{θ} represents model parameters of a backbone corresponding to each sub-model, and Ψ_{θ} represents model parameters of each sub-model.

It should be noted that backbones corresponding to respective sub-models may be the same or independent from one another; for example, the network structures of the backbones corresponding to the respective sub-models are the same, and the network parameters are different, or the network structures and the network parameters of the backbones corresponding to the respective sub-models are the same, which is not limited in this disclosure.

The embodiment of the present disclosure exemplifies that the sub-model of the identification model includes two branch models and one inverse distribution model, each branch model focusing on different focused category subsets in the training process. The number of said branch models may change with the number of the divided focused category subsets, or may be set in advance.

To illustrate the effect of this embodiment, 2-norm values of the weights of the classifiers of different branch models are shown in a bar graph in FIG. 3. The larger the 2-norm value is, the better optimization for such a category is. It can be seen that different branches do focus on different category subsets.

In some embodiments, training the inverse distribution model through a preset loss function based on full data comprises: determining a boundary distance between a category of a target sample label and a target category based on a ratio of a number of samples of the target category to a number of samples of the target sample label, and taking a logarithm thereof, and an inverse distribution coefficient; and adjusting an interval boundary of the category identified by the inverse distribution model according to the boundary distance.

The boundary distance is calculated based on the inverse distribution coefficient, and the inverse distribution model is trained, so that the inverse distribution model can effectively weaken the identification deviation generated by the branch model for categories outside the focused category subset.

FIG. 4 illustrates a flow chart of a method for identifying a sample data category according to an embodiment of the present disclosure. As shown in FIG. 4, training a sub-model through a preset loss function comprises:
Step S401, creating a loss function based on first adjusting data and classifier output data corresponding to a sub-model in a target sample label and second adjusting data and classifier output data corresponding to a the sub-model in a target category, wherein the target sample label is one of a plurality of sample labels of an input sample, and the target category is one of a plurality of categories in a training set; and
Step S402, training the sub-model through the loss function until the sub-model converges.

In some embodiments, before creating the loss function according to the classifier output data of the sub-model in the target sample label and the first adjusting data and the classifier output data of the sub-model in the target category and the second adjusting data, the method further comprises: calculating first adjusting data based on a first adjusting function and classifier output data of the target sample label; calculating second adjusting data based on a second adjusting function and classifier output data of the target category.

First adjusting data are calculated based on the first adjusting function and second adjusting data are calculated based on the second adjusting function, thereby creating a loss function based on the first adjusting data and the second adjusting data, and with the loss function having first adjusting data and second adjusting data, the identification capability of the identification model for the focused category subset is optimized.

In some embodiments, the first and second adjusting functions may be the same adjusting function. In this embodiment, a logarithmic function log( ) is used as the adjusting function, and for the first adjusting data and the second adjusting data, the same logarithmic function is used as the adjusting function, and the corresponding input data are different.

For the kth sub-model, the following loss function is used:

$$p ( {x}_{i} , k ) = \frac{{e}^{{v}_{{y}_{i}}^{k} + T ( k , {y}_{i} )}}{{\sum }_{j = 1}^{C} {e}^{{v}_{j}^{k} + T ( k , j )}}$$

In the formula, p(xᵢ, k) represents a loss function of the input sample xᵢ in the kth sub-model, v_{yi} represents an output from a classifier corresponding to the sample label yᵢ of the input sample xᵢ, vⱼ represents an output of the j-th category from the classifier, and T( ) represents an adjusting function.

The loss function p(xᵢ, k) is determined based on a ratio of output data

$${e}^{{v}_{{y}_{i}}^{k} + T ( k , {y}_{i} )}$$

of the input sample xᵢ to total output data

$${\sum }_{j = 1}^{C} {e}^{{v}_{j}^{k} + T ( k , j )}$$

of the respective categories 1 to C. In some embodiments, based on the adjusting function T( ) and the sample label yᵢ of the input sample xᵢ, i.e., classifier output data v_{yi} corresponding to the target sample label yᵢ, output data

$${e}^{{v}_{{y}_{i}}^{k} + T ( k , {y}_{i} )}$$

of the input sample is constructed; based on the adjusting function T( ) and the classifier output data vⱼ of each category j, output data

$${e}^{{v}_{j}^{k} + T ( k , j )}$$

of each category j is constructed; total output data

$${\sum }_{j = 1}^{C} {e}^{{v}_{j}^{k} + T ( k , j )}$$

is constructed according to the output data of each category.

The output data of the input sample is a result obtained by taking a sum of the classifier output v_{yi} corresponding to the sample label yᵢ of the input sample xᵢ and the first adjusting data T (k, yᵢ) of the input sample xᵢ as an index and taking e as a base number.

Output data f the j-th category is a result obtained by taking a sum of the classifier output vⱼ corresponding to the j-th category and the second adjusting data T(k, j) of the j-th category as an index and taking e as a base number.

Both the first adjusting data and the second adjusting data may be calculated by the adjusting function T( ).

$$T ( k , j ) = \{ \begin{matrix}log ( {n}_{j} ) , & j ∈ {C}_{k} , & k \neq K \\ log ( {n}_{m ax} ) , & j ∉ {C}_{k} , & k \neq K \\ τ \cdot log ( {n}_{j} ) , & k = K & \end{matrix}$$

In the formula, nⱼ represents a number of samples in the jth category, nₘₐₓ represents a maximum value of the number of samples in all the categories, K represents a total number of the sub-models, Cₖ represents a focused category subset of the kth sub-model, and τ represents an inverse distribution coefficient, wherein τ>1.

In some embodiments, according to the first and second adjusting functions, each sub-model is caused to increase an identification weight for categories belonging to the focused category subset or decrease an identification weight for categories not belonging to the focused category subset.

In some embodiments, the process of calculating the first adjusting data based on the first adjusting function and classifier output data corresponding to the target sample label is the same as a process of calculating the second adjusting data based on the second adjusting function and classifier output data corresponding to the target category. For convenience of presentation, the following describes in detail a process of calculating the second adjusting data according to the second adjusting function and the classifier output data corresponding to the target category.

Calculating the second adjusting data according to the second adjusting function and the classifier output data corresponding to the target category comprises: where the sub-model is a branch model, and the target category belongs to the focused category subset of the branch model, taking the logarithm according to the number of samples of the target category, and determining second adjusting data.

According to the second adjusting function, for the branch model, in a case that the target category belongs to the focused category subset, adjustment is performed according to the number of samples thereof, so that the less the number of samples of the target category, the more the branch model favors the identification of that target category.

Under the condition that the target category does not belong to a category subset focused by the branch model, a logarithm is taken according to the maximum value of the number of samples of each category in the training set, and second adjusting data are determined, wherein the maximum value of the sample number is a number of samples of the category with the largest number of samples in a plurality of categories in the training set. Under the condition that the target category does not belong to a category subset focused by the branch model, adjustment is performed using the maximum value of the sample number, so that the branch model weakens the identification optimization of that target category in the training process.

Under the condition that the sub-model is an inverse distribution model, second adjusting data are determined according to an inverse distribution coefficient and a logarithm of the number of samples of the target category. In some embodiments, in a range of full data, in the process of training the inverse distribution model, the optimization intensity of the identification capability of a category is inversely related to the number of samples of the category, that is, the inverse distribution is realized from the perspective of a loss function. The inverse distribution coefficient is greater than 1, and the setting of the inverse distribution coefficient can be used for further enhancing the optimization intensity of the inverse distribution model on the identification capability of the category with a small number of samples in the full data in the training process.

For the branch model, a deviation is generated when the category outside the corresponding focused category subset is identified, and the loss function determined by the method is used for training and optimizing the inverse distribution model, so that the identification deviation of the branch model for categories outside the focused category subset can be effectively relieved.

FIG. 5 illustrates a flow chart of a method of identifying a sample data category according to an embodiment of the present disclosure. As shown in FIG. 5, training a sub-model through a preset loss function comprises:
Step S501, determining a boundary distance between a category of a target sample label and a target category according to a difference between first adjusting data and second adjusting data; and
Step S502, according to the boundary distance, adjusting an interval boundary of the category identified by the sub-model.

Through the steps, a boundary distance function is calculated according to a first adjusting function and a second adjusting function, and a boundary distance is calculated according to the boundary distance function, so that the boundary distance is calculated quickly and accurately, and the data processing and calculating efficiency is improved.

Taking the above-mentioned loss function p(xᵢ, k) as an example, the loss function is transformed into the following formula by dividing both the numerator and denominator by the T (k, yᵢ) power of e:

$$P ( {x}_{i} , k ) = \frac{{e}^{{v}_{{y}_{i}}^{k}}}{{\sum }_{j = 1}^{C} {e}^{{v}_{j}^{k} + M ( {y}_{i} , j , k )}} \qquad ( 1 )$$

In the denominator of formula (1), a difference obtained by subtracting the first adjusting data T(k, yᵢ) from the second adjusting data T(k, j) is denoted as M(yᵢ, j, k), which a boundary distance function.

$$M ( {y}_{i} , j , k ) = \{ \begin{matrix}log ( \frac{{n}_{j}}{{n}_{{y}_{i}}} ) , & {y}_{i} ∈ {C}_{k} , j ∈ {C}_{k} , k \neq K & 2 - 1 \\ log ( \frac{{n}_{m ax}}{{n}_{{y}_{i}}} ) , & {y}_{i} ∈ {C}_{k} , j ∉ {C}_{k} , k \neq K & 2 - 2 \\ log ( \frac{{n}_{j}}{{n}_{m ax}} ) , & {y}_{i} ∉ {C}_{k} , j ∈ {C}_{k} , k \neq K & 2 - 3 \\ log ( \frac{{n}_{m ax}}{{n}_{ma x}} ) , & {y}_{i} ∉ {C}_{k} , j ∉ {C}_{k} , k \neq K & 2 - 4 \\ τ \cdot log ( \frac{{n}_{j}}{{n}_{{y}_{i}}} ) , & {y}_{i} , j ∈ C , k = K & 2 - 5\end{matrix} \qquad ( 2 )$$

In some embodiments, the boundary distance is determined according to a boundary distance function, and the branch model is trained so that the branch model is biased to the identification of a target category with a smaller number of samples in the focused category subset or a category corresponding to the target sample label, or to a category corresponding to a target sample label belonging to the focused category subset. The inverse distribution model is also enabled to effectively eliminate a bias generated by a category outside the focused category subset. In summary, the branch model is biased to identifying categories within the focused category subset.

In some embodiments, calculating the boundary distance according to the boundary distance function comprises: when the sub-model is a branch model and the target category and the target sample label both belong to the focused category subset of the branch model, determining the boundary distance by taking logarithm according to a ratio of the number of samples of the target category to the number of samples of the sample label.

According to the boundary distance function, under the condition that the category corresponding to the target sample label and the target category both belong to the focused category subset, the branch model is adjusted according to the ratio of the number of samples, and the identification of the category corresponding to the target sample label or the target category is more biased, so that in the learning process the branch model is biased to identifying the target category or the category corresponding to the target sample label with a smaller number.

Under the condition that the target category does not belong to the focused category subset of the branch model and the target sample label belongs to the focused category subset, a boundary distance is determined by taking a logarithm according to a ratio of the maximum value of the sample number of each category in the training set to the sample number of the target sample label, wherein the boundary distance is greater than or equal to 0.

Under the condition that the target category does not belong to the focused category subset and the category corresponding to the target sample label belongs to the focused category subset, a boundary distance is determined by taking a logarithm according to a ratio of the maximum value of the sample number of each category in the training set to the sample number of the target sample label, wherein the boundary distance is greater than or equal to 0, so that the branch model is biased to a category corresponding to the target sample label belonging to the focused category subset.

Under the condition that the target category belongs to the focused category subset of the branch model and the target sample label does not belong to the focused category subset, a boundary distance is determined by taking a logarithm according to a ratio of the sample number of the target category to a maximum value of the sample number of each category in the training set, wherein the boundary distance is less than or equal to 0.

Under the condition that the target category belongs to the focused category subset and the target sample label does not belong to the focused category subset, a boundary distance is determined by taking a logarithm according to a ratio of the sample number of the target category to a maximum value of the sample number of each category in the training set, wherein the boundary distance is less than or equal to 0, so that the branch model is biased to a target category belonging to the focused category subset.

Under the condition that neither the target category nor the target sample label belongs to the focused category subset of the branch model, it is determined the boundary distance is 0.

Under the condition that neither the target category nor the target sample label belongs to the focused category subset of the branch model, it is determined the boundary distance is 0, so that the branch model is biased to a category with more samples, which is an original capability of the branch model.

Under the condition that the sub-model is an inverse distribution model, the boundary distance is determined according to a ratio of the number of the samples of the target category to the number of the samples of the target sample label, for which a logarithm is taken, and an inverse distribution coefficient.

The inverse distribution model is adjusted according to a ratio of the number of samples of the target category to the number of samples of the target sample label and the inverse distribution coefficient, so that the inverse distribution model can effectively weaken the deviation generated by the categories outside the focused category subset.

FIG. 7 illustrates a flow chart of a method for identifying a sample data category according to an embodiment of the present disclosure. As shown in FIG. 7, in this embodiment, adjusting an interval boundary of a category identified by a sub-model according to a boundary distance on the basis of step S402 comprises:
Step S701, adjusting weights of a target category and a category corresponding to a target sample label according to the boundary distance, so as to adjust the interval boundary of the category identified by the sub-model.

The sub-model described above includes a classifier, which, in some examples, may include a fully connected layer. Category weights in the fully connected layer of the classifier of the sub-model are adjusted according to the boundary distance, so that the classifier would be biased to identification of a category of the corresponding focused category subset.

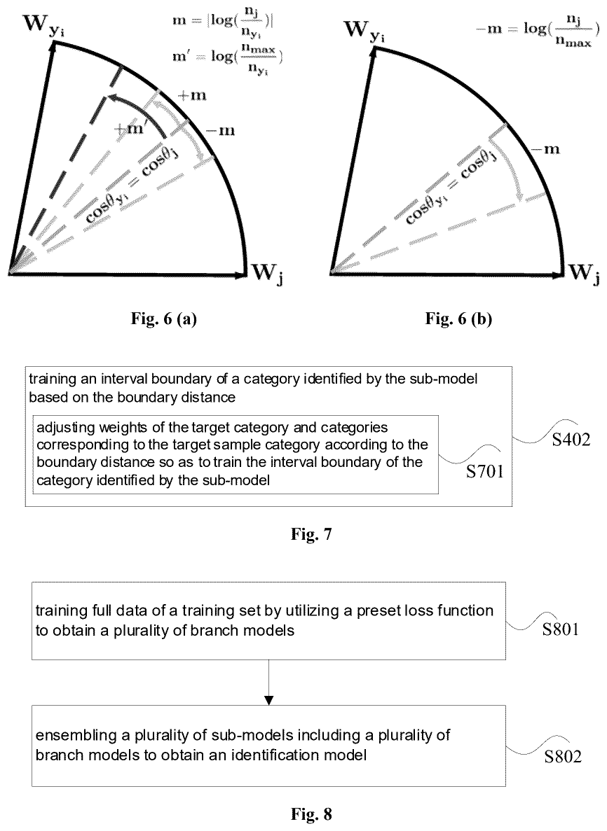

FIG. 6 identifies decision boundaries of branch models in different scenarios, where the decision boundaries are used to distinguish interval boundaries of categories identified by the branch models, and where the decision boundaries shift, corresponding interval boundaries would also change. FIG. 6(a) shows a case where the category corresponding to the target sample label yᵢ belongs to Cₖ, wherein a dashed line cos θ_{yi}=cos θⱼ, a dashed line +m and a dashed line −m respectively represent three cases of a decision boundary when the target category j belongs to Cₖ, and a dashed line +m′ represents a decision boundary when the target category j does not belong to Cₖ, in an extreme case, a decision boundary at which a dashed line cos θ_{yi}=cos θⱼ may also occur; FIG. 6(b) shows a case where a category corresponding to the target sample label yᵢ does not belong to Cₖ, the dashed line −m represents a decision boundary when the target category j belongs to Cₖ, and in an extreme case, a decision boundary of dashed line cos θ_{yi}=cos θⱼ may also occur; the dashed line cos θ_{yi}=cos θⱼ represents a decision boundary when the target category j does not belong to Cₖ.

In some embodiments, FIG. 6(a) further illustrates a schematic diagram of category weight adjustment according to a boundary distance in a case that a target sample label belongs to the focused category subset according to an embodiment of the present disclosure; FIG. 6(b) further illustrates a schematic diagram of category weight adjustment according to the boundary distance in a case that the target sample label does not belong to the focused category subset according to an embodiment of the present disclosure; w_{yi} in FIGS. 6(a) and 6(b) refers to a weight of the classifier of the k-branch model in identifying the corresponding category of yᵢ, and wⱼ refers to a weight of the classifier of the k-branch model in identifying the j-target category. M(yᵢ, j, k) represents a boundary distance between every two categories, which determines the deviation of a boundary surface between the two categories. As shown in FIGS. 6(a) and 6(b):
1. In the M function (i.e., M(yᵢ, j, k) function) of formula (2), formula 2-1 represents a value of the M function when the target sample label yᵢ and the target category j both belong to Cₖ, which is a focused category subset of the kth branch model.

If the number nⱼ of samples of the target category j is greater than the number n_{yi} of the samples of the target sample label yᵢ, the value of the M function is greater than 0, and a category with fewer samples can be optimized to a greater extent, and particularly, the identification optimization of the categories with fewer samples is biased in the branch model training process. The boundary surface between the two categories is shown by the dashed line +m in FIG. 6(a), which has a better optimization for the category corresponding to the target sample label yᵢ.

If the number nⱼ of samples of the target category j is smaller than the number n_{yi} of samples of the target sample label yᵢ, the value of the M function is smaller than 0, and the boundary surface between the two categories is shown by a dashed line −m in FIG. 6(a), which has better optimization for the target category.

No matter the identification optimization of the category corresponding to the target sample label or the identification optimization of the target category is biased, the identification optimization is carried out on the focused category subset of the branch model.

If the number nⱼ of samples of the target category j is equal to the number n_{yi} of samples of the target sample label yᵢ, a value of the M function is equal to 0, and the boundary is located in the middle between the two categories, where the optimization depends on the number of samples of the two categories themselves, that is, in the training process, an intensity of optimization of the two categories is positively correlated with the number of samples of the categories. The boundary surface between the two categories is shown as a dashed line cos θ_{yi}=cos θⱼ in FIG. 6(a).
2. In the M function (i.e., M(yᵢ, j, k) function) of formula (2), formula 2-2 represents a value of the M function when the target sample label yᵢ belongs to Cₖ and the target category j does not belong to Cₖ. If the number n_{yi} of samples of the target sample label yᵢ is smaller than the maximum number nₘₐₓ of the number of samples of each category in the training set, which is a case with great probability, the value of the formula 2-2 of the M function is larger than 0, and the boundary at this time is shown as a dashed line +m′ in FIG. 6(a), which has better optimization on the category corresponding to the target sample label yᵢ, and in this case, the category corresponding to the target sample label yᵢ belongs to Cₖ, which indicates that the category in Cₖ is the focus of optimization. In some embodiments, the number n_{yi} of samples of the target sample label yᵢ is equal to the maximum number nₘₐₓ of samples of each category in the training set, and thus, the value of the formula 2-2 of the M function is equal to 0, where the boundary is located in the middle between the two categories, where the optimization depends on the number of samples of the two categories themselves, and the boundary line between the two categories is shown as the dashed line cos θ_{yi}=cos θⱼ in FIG. 6(a).
3. In the M function (i.e., M(yᵢ, j, k) function) of formula (2), formula 2-3 represents a value of the M function when the target sample label yᵢ does not belong to Cₖ and the target category j belongs to Cₖ. If the number nⱼ of samples of the target category j is smaller than the maximum number nₘₐₓ of samples of each category in the training set, which is a case with great probability, the value of the formula 2-3 of the M function is less than 0, and the boundary is shown by the dashed line −m in FIG. 6(b), where the target category j belongs to Cₖ, and therefore, it is still the category in the Cₖ that is optimized.

In some embodiments, the number nⱼ of samples of the target category j is equal to the maximum number nₘₐₓ of samples of each category in the training set, the value of the formula 2-3 of the M function is equal to 0, the boundary line is located in the middle of the two categories, the optimization depends on the number of samples of the two categories themselves, and the boundary surface between the two categories is shown by the dashed line cos θ_{yi}=cos θⱼ in FIG. 6 (b).
4. In the M function (i.e., M(yᵢ, j, k) function) of the formula (2), the formula 2-4 represents a value of the M function when neither the target sample label yᵢ nor the target category j belongs to Cₖ. The value of the formula 2-4 of the M function is 0 if a ratio of nₘₐₓ to nₘₐₓ is 1, and the boundary surface is shown by the dashed line cos θ_{yi}=cos θⱼ in FIG. 6(b), where the boundary line is located in the middle of the two categories, where the optimization depends on the number of samples in the two categories themselves.

In summary, the loss function of the present embodiment mainly optimizes the categories in the focused category subset Cₖ of the branch model. Thus, the branch model has better identification capability for the data category in the focused category subset.

It can be seen that, when the boundary distances are different, the boundary of the target category or the category corresponding to the target sample label is shifted, and weights of the target category and the category corresponding to the target sample label are further adjusted.

According to the boundary distance, the weights of the category corresponding to the target sample label and the target category can be adjusted, and thus, the category interval of the focused category subset can be adjusted. In this way, the data categories in the focused category subset corresponding to the branch model are focused more in the training and optimization process.

In some embodiments, after adjusting the weights of the target category and the category corresponding to the target sample label according to the boundary distance to adjust the category interval of the focused category subset, the method further comprises: in the iteration process of the branch model, adjusting classifier parameters of the branch model according to adjusted weights of the target category and the category corresponding to the target sample label, wherein the weights are the classifier parameters of the branch model, and the classifier focuses on more on the focused category subset through the adjusted weights; performing iterative training according to the adjusted classifier parameters; under the condition that a preset iteration termination condition is satisfied, completing the training of the branch model; and under the condition that a preset iteration termination condition is not satisfied, continuously selecting a target category and a target sample label to continuously train the branch model.

The preset iteration termination condition may be that an iteration number reaches a preset number, or that a loss value reaches a preset threshold value, or the like. Under the condition that the preset iteration termination condition is that the loss value reaches a preset threshold value, classifier output data corresponding to the target category and the target sample label as well as the loss value of the loss function in the current iteration are calculated according to the adjusted weights; under the condition that the loss value reaches a preset loss threshold value, training of the branch model is completed, and a branch model focusing on the focused category subset is obtained; and under the condition that the loss value does not reach a preset loss threshold value, a target category and a target sample label are continuously selected to continuously train the branch model.

By obtaining the adjusted weight, the classifier of the branch model can be adjusted to train the branch model. By using the adjusted weight, classifier output data of the subsequent input samples and the loss value of the loss function in the current iteration are calculated.

It is to be noted that, when classifier output data of an input sample are calculated using the adjusted weight, the adjusted weight may be multiplied with the input sample x to obtain the output data.

Whether the training of the branch model is completed or not is determined according to the loss value. Under the condition that the loss value reaches a preset loss threshold value, training of the branch model is completed to obtain the branch model focusing on the focused category subset; and under the condition that the loss value does not reach a preset loss threshold value, a target category and a target sample label are continuously selected to continuously train the branch model.

The classifier parameters are adjusted according to the adjusted weight, and iterative training on the branch model is performed by using full data of the inputted training set until the loss value of the loss function reaches a preset loss threshold value. In this way, the trained branch model has identification bias for the focused category subset.

Correspondingly, referring to FIG. 8, which illustrates a flow chart of a method for training a model for identifying a sample data category according to an embodiment of the present disclosure. An embodiment of the present disclosure provides a method for training an identification model for sample data identification, the method comprising:
Step S801, training full data of a training set by utilizing a preset loss function to obtain a plurality of branch models, wherein each branch model focuses on a corresponding focused category subset in the full data, and the focused category subset is at least one category in a plurality of categories in the full data; and
Step S802, ensembling a plurality of sub-models including a plurality of branch models to obtain an identification model, wherein the identification model is used for identifying an input sample and determining a category to which the input sample belongs.

Said steps adopt a method of ensembling a plurality of sub-models, and an identification accuracy of the identification model after fusion is improved through the diversity of the focused category subsets of a plurality of different sub-models. The input data of each branch model in the sub-models is the full data of a training set, and by a design of the loss function, different branches focus on different focused category subsets, so that the imbalance degree of the data can be reduced by each branch model, the identification effect of the focused category subset is improved, and finally the identification effect is integrally improved by fusing different branches.

In some embodiments, training full data of a training set by utilizing a preset loss function to obtain a plurality of branch models comprises: dividing the full data into focused category subsets corresponding to the plurality of branch models according to a number of the branch models, wherein the branch models correspond to the focused category subsets on a one-to-one basis, and the sample number of each focused category subset is within a preset range of sample number; and training the plurality of branch models according to the full data, wherein in the training process, the branch models are trained through a preset loss function to obtain a plurality of branch models.

By adopting a method of ensembling multiple branch models, through the diversity of the focused category subsets of a plurality of different branch models, the identification accuracy of the identification model after fusion is improved.

In some embodiments, the plurality of sub-models further comprise: an inverse distribution model, the method further comprising: training the inverse distribution model through a preset loss function based on the full data, wherein the preset loss function is determined through an inverse distribution coefficient; and the step of ensembling a plurality of sub-models including a plurality of branch models to obtain an identification model comprises: ensembling the inverse distribution model and the plurality of branch models to obtain an identification model.

A deviation generated by the plurality of branch models in categories outside the focused category subset is eliminated through the inverse distribution model, so that the identification accuracy of the finally fused identification model is higher.

In some embodiments, training the inverse distribution model with a preset loss function based on the full data comprises: determining a boundary distance between the category of the target sample label and the target category according to a ratio of the number of samples of the target category to the number of samples of the target sample label, with a logarithm being taken, and an inverse distribution coefficient; and adjusting an interval boundary of the category identified by the inverse distribution model according to the boundary distance.

The boundary distance is calculated through the inverse distribution coefficient, and the inverse distribution model is trained, so that the inverse distribution model can effectively weaken the deviation generated by the categories outside the focused category subset.

In some embodiments, in the training process, training the branch model by a preset loss function to obtain a plurality of branch models comprises: creating a loss function according to classifier output data corresponding to the sub-model in a target sample label and first adjusting data and classifier output data corresponding to the sub-model in a target category and second adjusting data, wherein the target sample label is one of a plurality of sample labels of an input sample, and the target category is one of a plurality of categories in full data; and training the sub-models through a loss function until the models converge.

A loss function is created by combining the first adjusting data and the second adjusting data, a boundary distance is calculated, and the interval boundary of the category identified by the sub-model is adjusted according to different values of the boundary distance.

In some embodiments, before creating a loss function according to classifier output data corresponding to the sub-model in a target sample label and first adjusting data and classifier output data corresponding to the sub-model in a target category and second adjusting data, the method further comprises: calculating first adjusting data according to a first adjusting function and classifier output data corresponding to the target sample label; calculating second adjusting data according to a second adjusting function and classifier output data corresponding to the target category; the first and second adjusting functions are the same function.

The first adjusting data are calculated according to the first adjusting function, the second adjusting data are calculated according to the second adjusting function, thereby creating a loss function according to the first adjusting data and the second adjusting data, and weights of different categories are adjusted by using the loss functions with the first adjusting data and the second adjusting data, thereby optimizing the identification capability of the identification model on the focused category subset.

In some embodiments, training the sub-model by a preset loss function comprises: determining a boundary distance between the category of the target sample label and the target category according to a difference between the first adjusting data and the second adjusting data; and adjusting an interval boundary of the category identified by the sub-model according to the boundary distance.

A distance between a category of the target sample label and a target category is determined according to the first adjusting data and the second adjusting data, and the sub-models are trained according to the boundary distance. In this way, the branch model is more biased to identifying categories within the focused category subset.

In some embodiments, determining the boundary distance between the category of the target sample label and the target category based on a difference between the first adjusting data and the second adjusting data comprises: where the sub-model is a branch model, under the condition that the target category and the target sample label both belong to a focused category subset of the branch model, determining the boundary distance by taking a logarithm according to a ratio of the number of samples of the target category to the number of samples of the sample label; under the condition that the target category does not belong to the focused category subset of the branch model and the target sample label belongs to the focused category subset, determining the boundary distance by taking a logarithm according to a ratio of a maximum value of the sample number of each category in the training set to the sample number of the target sample label, wherein the boundary distance is greater than 0; under the condition that the target category belongs to the focused category subset of the branch model and the target sample label does not belong to the focused category subset, determining the boundary distance by taking a logarithm according to a ratio of the sample number of the target category to the maximum value of the sample number of each category in the training set, wherein the boundary distance is less than 0; and under the condition that neither the target category nor the target sample label belongs to the focused category subset of the branch model, determining that the boundary distance is 0.

According to a function of the boundary distance, the branch model is enabled to be biased to identifying a target category with less samples in the focused category subset or the category corresponding to the target sample label. Alternatively, the branch model is enabled to be biased to identifying the category corresponding to the target sample label belonging to the focused category subset. In summary, the branch model is enabled to be biased to identifying categories within the focused category subset.

In some embodiments, adjusting the interval boundary of the category identified by the sub-model according to the boundary distance comprises: adjusting weights of the target category and the category corresponding to the target sample label according to the boundary distance so as to adjust the interval boundary of the category identified by the sub-model.

The category weight of the classifier is adjusted according to the boundary distance, so that the classifier more preferentially identifies the category of the focused category subset according to the boundary distance.

In some embodiments, after adjusting the weights of the target category and the category corresponding to the target sample label according to the boundary distance to adjust the category interval of the focused category subset, the method further comprises: in the iteration process of the branch model, adjusting classifier parameters of the branch model according to adjusted weights of the target category and the category corresponding to the target sample label, wherein the weights are the classifier parameters of the branch model, and the classifier focuses more on the focused category subset through the adjusted weights; performing iterative training according to the adjusted classifier parameters; under the condition that a preset iteration termination condition is satisfied, completing the training of the branch model; and under the condition that a preset iteration termination condition is not satisfied, continuously selecting a target category and a target sample label to continuously train the branch model.

The classifier parameters are adjusted according to the adjusted weights, and iterative training is performed on the branch model by using full data of the inputted training set until a preset iteration termination condition is satisfied. In this way, the trained branch model is biased to identification of the focused category subset.

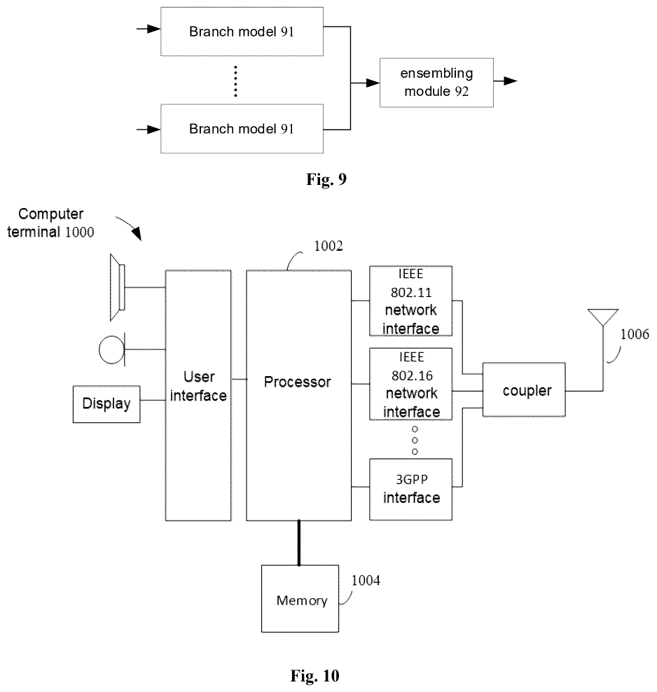

Accordingly, referring to FIG. 9, which illustrates a schematic diagram of an identification model for sample data category according to an embodiment of the present disclosure. An embodiment of the present disclosure provides an identification model of sample data category, the system comprising: a plurality of sub-models 91, and an ensembling module 92; the system is described in detail below.

The plurality of sub-models 91 comprise a plurality of branch models 911, which are obtained by training according to full data of a training set through a preset loss function, each branch model focusing on a corresponding focused category subset in the full data, and the focused category subset being at least one category in the plurality of categories in the training set.

The ensembling module 92 is connected to outputs of the plurality of sub-models 91, and is configured to ensemble output data from the plurality of sub-models to obtain a final identification result.

By utilizing the identification model, through the diversity of the focused category subsets of a plurality of different sub-models, the identification accuracy of the identification model after fusion is improved. The input data of each branch model is the full data of the training set, and different branches focus on different focused category subsets through the design of a loss function, so that the imbalance degree of the data can be reduced by each branch model, the identification effect of the focused category subsets is improved, and finally the identification effect is integrally improved by fusing different branches.

In some embodiments, when training the plurality of branch models with a preset loss function according to the full data of the training set: dividing the full data into focused category subsets corresponding to the plurality of branch models according to the number of the branch models, wherein the branch models correspond to the focused category subsets on a one-to-one basis, and the sample number of each focused category subset is within a preset range of sample number; and training the plurality of branch models according to the full data, and training the branch models through a preset loss function in the training process.

In some embodiments, the plurality of sub-models further comprise: an inverse distribution model, which is obtained by training an inverse distribution model through a preset loss function based on full data, and the loss function of the inverse distribution model is determined through an inverse distribution coefficient. When a plurality of sub-models including a plurality of branch models are ensembled to obtain an identification model, the inverse distribution model and the plurality of branch models are ensembled to obtain the identification model.

In some embodiments, when the inverse distribution model is trained through a preset loss function based on the full data: determining a boundary distance between the category of the target sample label and the target category according to a ratio of the number of samples of the target category to the number of samples of the target sample label, a logarithm being taken, and an inverse distribution coefficient; and adjusting an interval boundary of the category identified by the inverse distribution model according to the boundary distance.

In some embodiments, when training the sub-models by a preset loss function: creating a loss function according to classifier output data corresponding to the sub-model in a target sample label and first adjusting data and classifier output data corresponding to the sub-model in a target category and second adjusting data, wherein the target sample label is one of a plurality of sample labels of an input sample, and the target category is one of a plurality of categories in full data; training the sub-models through the loss function until the models converge.

In some embodiments, before creating a loss function according to classifier output data corresponding to the sub-model in a target sample label and first adjusting data and classifier output data corresponding to the sub-model in a target category and second adjusting data, first adjusting data are calculated according to a first adjusting function and classifier output data corresponding to the target sample label; second adjusting data are calculated according to a second adjusting function and classifier output data corresponding to the target category; the first and second adjusting functions are the same function.

In some embodiments, when training the sub-models by a preset loss function: determining a boundary distance between the category of the target sample label and the target category according to a difference between the first adjusting data and the second adjusting data; and adjusting an interval boundary of the category identified by the sub-model according to the boundary distance.

In some embodiments, when determining the boundary distance between the category of target sample label and the target category based on the difference between the first adjusting data and the second adjusting data: when the sub-model is a branch model, under the condition that the target category and the target sample label both belong to the focused category subset of the branch model, determining the boundary distance by taking a logarithm according to a ratio of the number of samples of the target category to the number of samples of the sample label; under the condition that the target category does not belong to the focused category subset of the branch model and the target sample label belongs to the focused category subset, determining the boundary distance by taking a logarithm according to a ratio of a maximum value of the sample number of each category in the training set to the sample number of the target sample label, wherein the boundary distance is greater than 0; under the condition that the target category belongs to the focused category subset of the branch model and the target sample label does not belong to the focused category subset, determining the boundary distance by taking a logarithm according to a ratio of the sample number of the target category to a maximum value of the sample number of each category in the training set, wherein the boundary distance is less than 0; and under the condition that neither the target category nor the target sample label belongs to the focused category subset of the branch model, determining that the boundary distance is 0.

In some embodiments, when adjusting the interval boundary of the category identified by the sub-model according to the boundary distance: adjusting the weights of the target category and the category corresponding to the target sample label according to the boundary distance so as to adjust the interval boundary of the category identified by the sub-model.

In some embodiments, after adjusting the weights of the target category and the category corresponding to the target sample label according to the boundary distance so as to adjust the category interval of the focused category subset, in the iterative process of the branch model, the classifier parameters of the branch model are adjusted according to the adjusted weights of the target category and the category corresponding to the target sample label, wherein the weights are the classifier parameters of the branch model, and the adjusted weights enable the classifier to focus more on the focused category subset; iterative training is performed according to the adjusted classifier parameters; under the condition that a preset iteration termination condition is satisfied, training of the branch model is completed; and under the condition that a preset iteration termination condition is not satisfied, a target category and a target sample label are continuously selected to continuously train the branch model.

The network detecting device comprises a processor and a memory, and the sub-model 91, the ensembling module 92 and the like can be stored in the memory as program units, and the processor executes the program units stored in the memory to realize corresponding functions.

The processor comprises a kernel that calls a corresponding program unit from the memory. The kernel can be set to be one or more than one, and when an efficiency of network transmission is improved, the position and the reason of network abnormality are determined by acquiring and attributing multi-dimensional network data of a client of a network to be detected, and then the network is perfected and improved in a targeted manner, which will result in more efficient and rapid optimization of network transmission.

The memory may include volatile memory in a computer-readable medium, Random Access Memory (RAM) and/or non-volatile memory, such as Read Only Memory (ROM) or flash memory (flash RAM), including at least one memory chip.

An embodiment of the present disclosure provides a computer-readable storage medium with a program stored thereon, the program, when executed by a processor, performing a training method or a network detection display method of an identification model of a sample data type.

FIG. 10 illustrates a schematic diagram of a computer terminal according to an embodiment of the disclosure. As shown in FIG. 10, the embodiment of the disclosure provides a computer terminal 1000 which includes a processor 1002, a memory 1004, and a program stored on the memory and operable on the processor.

In the present application, technical solutions in the above embodiment each can be applied to the computer terminal 1000 shown in FIG. 10. The computer terminal 1000 can include one or more (only one shown) processors 1002 (the processors 1002 can include, but are not limited to, a processing device such as a microprocessor MCU or a programmable logic device FPGA, etc.), memory 1004 for storing data, and a transmission module 1006 for communication functions. It will be understood by those skilled in the art that the structure shown in FIG. 10 is only illustrative and is not intended to limit the structure of the electronic device. For example, the computer terminal 1000 can also include more or fewer components than that shown in FIG. 10, or can have a configuration different from that shown in FIG. 10.

The memory 1004 may be used to store software programs of application software and modules, and the processor 1002 may execute various functional applications and data processing by operating the software programs and modules stored in the memory 1004. The memory 1004 may include high-speed random access memory, and may also include non-volatile memory, such as one or more magnetic storage devices, flash memory, or other non-volatile solid-state memory. In some examples, the memory 1004 can further include memory located remotely from the processor 1002, which can be connected to the computer terminal 1000 through a network. Examples of such a network include, but are not limited to, internets, intranets, local area networks, mobile communication networks, and combinations thereof.

The transmission device 1006 is used for receiving or sending data via a network. Specific examples of the network described above may include a wireless network provided by a communication provider of the computer terminal 1000. In one example, the transmission device 1006 includes a network adapter (Network Interface Controller (NIC)) that can be connected to other network devices through a base station so as to communicate with the internet. In one example, the transmission device 1006 can be a Radio Frequency (RF) module, which is used to communicate with the internet in a wireless manner.

Steps of the method for identifying the sample data category are performed when the processor executes a program:
inputting an input sample to be identified into an identification model, wherein the identification model is obtained by ensembling a plurality of sub-models that include a plurality of branch models obtained by training full data of a training set by using a preset loss function, each branch model focusing on a corresponding focused category subset in the full data, and the focused category subset being at least one of a plurality of categories in the full data; and identifying a category to which the input sample belongs according to the output from the identification model.

The branch model that is obtained by training full data of the training set by using a preset loss function has higher identification capability for the focused category subset, and the identification model obtained by ensembling a plurality of branch models has better identification capability for all categories of the training set. The identification model is adopted to identify the input sample, so that a higher identification accuracy is achieved.

In some embodiments, before inputting the input sample to be identified to the identification model, the method further comprises: dividing the full data into focused category subsets corresponding to a plurality of the branch models according to a number of the branch models, wherein the branch models correspond to the focused category subsets on a one-to-one basis, and the sample number of each focused category subset is within a preset range of sample number; training a plurality of branch models according to the full data, and training the branch models through a preset loss function in the training process; and ensembling the plurality of branch models to obtain an identification model.

By adopting a multi-branch model ensembling method, through the diversity of a plurality of different branch models, the identification accuracy of the identification model after fusion is improved. The input data from each branch model is the full data of the training set, and different branches focus on different focused category subsets through the design of a loss function, so that the imbalance degree of the data can be reduced by each branch model, the identification effect of the focused category subsets is improved, and finally the identification effect is integrally improved by fusing different branches.

In some embodiments, the plurality of sub-models further comprises: an inverse distribution model, the method further comprising: training the inverse distribution model through a preset loss function based on the full data, wherein the preset loss function is determined through an inverse distribution coefficient; and ensembling the inverse distribution model and a plurality of branch models to obtain an identification model.

A deviation generated by the plurality of branch models in categories outside the focused category subset is eliminated through the inverse distribution model, so that the identification accuracy of the finally fused identification model is higher.

In some embodiments, training the inverse distribution model with a preset loss function based on the full data comprises: determining a boundary distance between a category of a target sample label and a target category according to a ratio of the number of samples of the target category to a number of samples of the target sample label, with a logarithm taken, and an inverse distribution coefficient; and adjusting an interval boundary of the category identified by the inverse distribution model according to the boundary distance.

The boundary distance is calculated through the inverse distribution coefficient and the inverse distribution model is trained, so that the inverse distribution model can effectively eliminate the deviation generated by the categories outside the focused category subset.

In some embodiments, training the sub-model with a preset loss function comprises: creating a loss function according to classifier output data corresponding to the sub-model in a target sample label and first adjusting data and classifier output data corresponding to the sub-model in a target category and second adjusting data, wherein the target sample label is one of a plurality of sample labels of an input sample, and the target category is one of a plurality of categories in full data; and training the sub-models through the loss function until the models converge.

The loss function is created by combining the first adjusting data and the second adjusting data, the boundary distance is calculated, and an interval boundary of the categories identified by the sub-models is adjusted according to different values of the boundary distance.

In some embodiments, before creating a loss function according to classifier output data corresponding to the sub-model in a target sample label and first adjusting data and classifier output data corresponding to the sub-model in a target category and second adjusting data, the method further comprises: calculating first adjusting data according to a first adjusting function and classifier output data corresponding to the target sample label; calculating second adjusting data according to a second adjusting function and classifier output data corresponding to the target category; the first and second adjusting functions are the same function.

The first adjusting data are calculated according to the first adjusting function, and the second adjusting data are calculated according to the second adjusting function, thereby creating a loss function according to the first adjusting data and the second adjusting data, and weights of different categories are adjusted by using the loss function with the first adjusting data and the second adjusting data, thereby optimizing the identification capability of the identification model on focused category subsets.

In some embodiments, training the sub-model with a preset loss function comprises: determining a boundary distance between the category of the target sample label and the target category according to a difference between the first adjusting data and the second adjusting data; and adjusting an interval boundary of the category identified by the sub-model according to the boundary distance.

A distance between a category of the target sample label and a target category is determined according to the first adjusting data and the second adjusting data, and the sub-model is trained according to the boundary distance, so that the branch model focuses more on identification of categories within the focused category subsets.

In some embodiments, determining the boundary distance between the category of target sample label and the target category according to a difference between the first adjusting data and the second adjusting data comprises: under the condition that the target category and the target sample label both belong to the focused category subset of the branch model, determining a boundary distance by taking a logarithm according to a ratio of the number of samples of the target category to the number of samples of the sample label; under the condition that the target category does not belong to the focused category subset of the branch model and the target sample label belongs to the focused category subset, determining the boundary distance by taking a logarithm according to a ratio of the maximum value of the sample number of each category in the training set to the sample number of the target sample label, wherein the boundary distance is greater than 0; under the condition that the target category belongs to the focused category subset of the branch model and the target sample label does not belong to the focused category subset, determining the boundary distance by taking a logarithm according to a ratio of the sample number of the target category to the maximum value of the sample number of each category in the training set, wherein the boundary distance is less than 0; and under the condition that neither the target category nor the target sample label belongs to the focused category subset of the branch model, determining that the boundary distance is 0.

According to the boundary distance function, the branch model focuses more on identifying the target category with less samples in the category subset or the category corresponding to the target sample label. Alternatively, the branch model focuses more on identifying the category corresponding to the target sample label belonging to the focused category subset. In summary, the branch model is made to focus more on identifying categories within the focused category subset.

In some embodiments, adjusting the interval boundary of the category identified by the sub-model according to the boundary distance comprises: adjusting weights of the target category and the category corresponding to the target sample label according to the boundary distance so as to adjust the interval boundary of the category identified by the sub-model.

The category weight of the classifier is adjusted according to the boundary distance, so that the classifier focuses more on identification of categories of the focused category subset according to the boundary distance.

In some embodiments, after adjusting the weights of the target category and the category corresponding to the target sample label according to the boundary distance to train the category interval of the focused category subset, the method further comprises: in the iteration process of the branch model, adjusting the classifier parameters of the branch model according to adjusted weights of the target category and the target sample label, wherein the weights are classifier parameters of the branch model, and the adjusted weights enable the classifier to focus more on the corresponding focused category subset; performing iterative training according to the adjusted classifier parameters; under the condition that a preset iteration termination condition is satisfied, completing the training of the branch model; and under the condition that a preset iteration termination condition is not satisfied, continuously selecting a target category and a target sample label to continuously train the branch model.

The classifier parameters are adjusted according to the adjusted weights, and iterative training is performed on the branch model by using the full data inputted to the training set until a preset iteration termination condition is satisfied. In this way, the trained branch model has a preference to identification of the focused category subsets.

Steps of the method for training an identification model of said training set are performed when the processor executes a program:
a method for training an identification model of a training set, the method comprising: training full data of a training set by utilizing a preset loss function to obtain a plurality of branch models, wherein each branch model focuses on respective focused category subset in the full data, and the focused category subset is at least one category in a plurality of categories in the full data; and ensembling a plurality of sub-models comprising the plurality of branch models to obtain an identification model, wherein the identification model is used for identifying an input sample and determining the category of the input sample.

By adopting a multi-branch model ensembling method, through the diversity of the focused category subsets of a plurality of different branch models, the identification accuracy of the identification model after fusion is improved.

The application also provides a computer program product, which, when executed on a processing device for job monitoring data, is adapted to perform a program initialized with any of the above method steps.

As will be appreciated by those skilled in the art, embodiments of the present application may be provided as a method, a system, or a computer program product. Accordingly, the present application may take the form of an entirely hardware embodiment, an entirely software embodiment or an embodiment combining software and hardware aspects. Furthermore, the present application may take the form of a computer program product embodied on one or more computer-usable storage media (including, but not limited to, disk storage, CD-ROM, optical storage, and the like) having computer-usable program code embodied thereon.

The present application has been described with reference to flowchart illustrations and/or block diagrams of methods, apparatus (systems), and computer program products according to embodiments of the application. It will be understood that each flow and/or block of the flowchart illustrations and/or block diagrams, and combinations of flows and/or blocks in the flowchart illustrations and/or block diagrams, can be implemented by computer program instructions.

These computer program instructions may be provided to a processor of a general purpose computer, a special purpose computer, an embedded processor, or another processing device of programmable job monitoring data to produce a machine, such that the instructions executed via the processor of the computer or the other processing device of programmable job monitoring data generate means for implementing the functions specified in one or more flows of the flowchart and/or one or more blocks of the block diagram.

These computer program instructions may also be stored in a computer-readable memory that can direct a computer or another processing device of programmable job monitoring data to operate in a particular manner, such that the instructions stored in the computer-readable memory produce an article including instruction means which implement the functions specified in one or more flows of the flowchart and/or one or more blocks of the block diagram.

These computer program instructions may also be loaded onto a computer or another processing device of programmable job monitoring data to cause a series of operational steps to be performed on the computer or other programmable device to produce a computer implemented process such that the instructions executed on the computer or other programmable device provide steps for implementing the functions specified in one or more flows of the flowchart and/or one or more blocks of the block diagram.

In a typical configuration, a computing device includes one or more processors (CPUs), input/output interfaces, network interfaces, and memory.

The memory may include forms of volatile memory, Random Access Memory (RAM) and/or non-volatile memory, such as Read Only Memory (ROM) or flash memory (flash RAM), in a computer-readable medium. The memory is an example of a computer-readable medium.

Computer-readable media, including both volatile and non-volatile, removable and non-removable media, may store information by any method or technology. The information may be computer-readable instructions, data structures, modules of a program, or other data. Examples of computer storage media include, but are not limited to, phase change memory (PRAM), Static Random Access Memory (SRAM), Dynamic Random Access Memory (DRAM), other types of Random Access Memory (RAM), Read Only Memory (ROM), Electrically Erasable Programmable Read Only Memory (EEPROM), flash memory or other memory technology, compact disc read only memory (CD-ROM), Digital Versatile Disks (DVD) or other optical storage, magnetic cassettes, magnetic tape, magnetic disk storage or other magnetic storage devices, or any other non-transmission medium, which can be used to store information accessible by a computing device. As defined herein, the computer-readable media do not include transitory computer-readable media such as modulated data signals and carrier waves.

It should also be noted that the terms “comprises,” “comprising,” or any other variation thereof, are intended to cover a non-exclusive inclusion, such that a process, method, article, or device that comprises a list of elements includes not only those elements but also other elements not expressly listed, or may include elements inherent to such a process, method, article, or device. Without further limitation, an element defined by the phrase “comprising a/an . . . ” does not exclude the presence of other identical elements in the process, method, article, or device that comprises the element.

As will be appreciated by those skilled in the art, embodiments of the present application may be provided as a method, system, or computer program product. Accordingly, the present application may take the form of an entirely hardware embodiment, an entirely software embodiment or an embodiment combining software and hardware aspects. Furthermore, the present application may take the form of a computer program product embodied on one or more computer-usable storage media (including, but not limited to, disk storage, CD-ROM, optical storage, and the like) having computer-usable program code embodied thereon.

The above description is only an example of the present application and is not intended to limit the present application. Various modifications and variations to this application will become apparent to those skilled in the art. Any modification, equivalent replacement, or improvement made within the spirit and principle of the present application should be included in the scope of the claims of the present application.

Although the embodiments of the present disclosure have been described in conjunction with the accompanying drawings, those skilled in the art can make various modifications and variations without departing from the spirit and scope of the present disclosure, and such modifications and variations fall within the scope defined by the appended claims.

1. An identification method for a sample data category, the method comprising:
inputting a sample to be identified to an identification model, wherein the identification model is obtained by ensembling a plurality of sub-models, the plurality of sub-models comprising a plurality of branch models that are obtained by training full data of a training set through a preset loss function, each branch model focusing on a focused category subset corresponding to each branch model in the full data, and the focused category subset being at least one category in a plurality of categories in the full data;
identifying the category to which the input sample belongs according to the output of the identification model.

2. The identification method according to claim 1, further comprising, prior to said inputting the sample to be identified to an identification model:
dividing the full data into focused category subsets corresponding to the plurality of branch models according to a number of the plurality of branch models, wherein the plurality of branch models correspond to the focused category subsets on a one-to-one basis, and the number of samples of each focused category subset is within a preset range of sample number;
training the plurality of branch models according to the full data, wherein the branch models are trained through a preset loss function in the training process;
ensembling the plurality of branch models to obtain an identification model.

3. The identification method according to claim 1, wherein the plurality of sub-models further comprises: an inverse distribution model,
the identification method further comprising:
training the inverse distribution model through the preset loss function based on the full data, wherein the preset loss function is determined through an inverse distribution coefficient;
ensembling the inverse distribution model and the plurality of branch models to obtain the identification model.

4. The identification method according to claim 3, wherein the training, based on the full data, of the inverse distribution model through the preset loss function comprises:
determining a boundary distance between a category of the target sample label and the target category according to a logarithm of a ratio of the number of samples of the target category to the number of samples of the target sample label and the inverse distribution coefficient; and
adjusting an interval boundary of the category identified by the inverse distribution model according to the boundary distance.

5. The identification method according to claim 1, wherein the plurality of sub-models are trained through the preset loss function by:
creating a loss function based on classifier output data corresponding to a sub-model in a target sample label and first adjusting data and classifier output data corresponding to the sub-model in a target category and second adjusting data, wherein the target sample label is one of a plurality of sample labels of an input sample, and the target category is one of a plurality of categories in the full data;
training the sub-model through the loss function.

6. The identification method according to claim 5, wherein before creating a loss function based on classifier output data corresponding to a sub-model in a target sample label and first adjusting data and classifier output data corresponding to the sub-model in a target category and second adjusting data, the method further comprises:
calculating first adjusting data according to a first adjusting function and classifier output data corresponding to the target sample label;
calculating second adjusting data according to a second adjusting function and classifier output data corresponding to the target category;
wherein the first adjusting function and the second adjusting function are the same function.

7. The identification method according to claim 5, wherein the plurality of sub-models are trained through the preset loss function by:
determining a boundary distance between the category of the target sample label and the target category according to a difference between the first adjusting data and the second adjusting data;
adjusting an interval boundary of the category identified by the sub-model according to the boundary distance.

8. The identification method according to claim 7, wherein determining a boundary distance between the category of the target sample label and the target category according to a difference between the first adjusting data and the second adjusting data comprises at least one of:
in response to the target category and the target sample label both belonging to a focused category subset of the branch model, determining the boundary distance according to a ratio of the sample number of the target category to the sample number of the sample label with a logarithm being taken;
in response to the target category not belonging to a focused category subset of the branch model, the target sample label belonging to the focused category subset, determining the boundary distance according to a logarithm of a ratio of a maximum value of a sample number of each category in the training set to a sample number of the target sample label, wherein the boundary distance is greater than 0;
in response to the target category belonging to a focused category subset of the branch model, the target sample label not belonging to the focused category subset, determining the boundary distance according to a logarithm of a ratio of a sample number of the target category to a maximum value of sample number of each category in the training set, wherein the boundary distance is less than 0;
in response to neither the target category nor the target sample label belonging to a focused category subset of the branch model, determining the boundary distance is 0.

9. The identification method according to claim 7, wherein the adjusting the interval boundary of the category identified by the sub-model according to the boundary distance comprises:
adjusting weights of categories corresponding to the target category and the target sample category according to the boundary distance so as to adjust the interval boundary of the category identified by the sub-model.

10. The identification method according to claim 9, wherein after adjusting the weights of the target category and the categories corresponding to the target sample label according to the boundary distance, the method further comprises:
in an iteration process of the branch model, adjusting classifier parameters of the branch model according to adjusted weights of the target category and categories corresponding to the target sample label, wherein the weights are the classifier parameters of the branch model, and the adjusted weights enable the classifier to focus more on the focused category subset;
performing iterative training according to the adjusted classifier parameters;
in response to satisfying a preset iteration termination condition, completing the training of the branch model;
in response to not satisfying the preset iteration termination condition, continuing to select a target category and a target sample label to continue training of the branch model.

11. A training method for an identification model of a sample data category, comprising:
training full data of a training set by utilizing a preset loss function to obtain a plurality of branch models, wherein each branch model focuses on a focused category subset corresponding to each branch model in the full data, and the focused category subset is at least one category in a plurality of categories in the full data;
ensembling a plurality of sub-models comprising the plurality of branch models to obtain an identification model, wherein the identification model is configured for identifying an input sample and determining the category to which the input sample belongs.

12. (canceled)

13. A non-transitory computer-readable storage medium for storing a program that performs the identification method for a sample data category according to claim 1.

14. An electronic device, comprising one or more processors and a memory for storing one or more programs, which, when executed by the one or more processors, cause the one or more processors to perform an identification method for a sample data category, comprising:
inputting a sample to be identified to an identification model, wherein the identification model is obtained by ensembling a plurality of sub-models, the plurality of sub-models comprising a plurality of branch models that are obtained by training full data of a training set through a preset loss function, each branch model focusing on a focused category subset corresponding to each branch model in the full data, and the focused category subset being at least one category in a plurality of categories in the full data;
identifying the category to which the input sample belongs according to the output of the identification model.

15. (canceled)

16. The electronic device according to claim 14, further comprising, prior to said inputting the sample to be identified to an identification model:
dividing the full data into focused category subsets corresponding to the plurality of branch models according to a number of the plurality of branch models, wherein the plurality of branch models correspond to the focused category subsets on a one-to-one basis, and the number of samples of each focused category subset is within a preset range of sample number;
training the plurality of branch models according to the full data, wherein the branch models are trained through a preset loss function in the training process;
ensembling the plurality of branch models to obtain an identification model.

17. The electronic device according to claim 14, wherein the plurality of sub-models further comprises: an inverse distribution model,
the identification method further comprising:
training the inverse distribution model through the preset loss function based on the full data, wherein the preset loss function is determined through an inverse distribution coefficient;
ensembling the inverse distribution model and the plurality of branch models to obtain the identification model.

18. The electronic device according to claim 17, wherein the training, based on the full data, of the inverse distribution model through the preset loss function comprises:
determining a boundary distance between a category of the target sample label and the target category according to a logarithm of a ratio of the number of samples of the target category to the number of samples of the target sample label and the inverse distribution coefficient; and
adjusting an interval boundary of the category identified by the inverse distribution model according to the boundary distance.

19. The electronic device according to claim 14, wherein the plurality of sub-models are trained through the preset loss function by:
creating a loss function based on classifier output data corresponding to a sub-model in a target sample label and first adjusting data and classifier output data corresponding to the sub-model in a target category and second adjusting data, wherein the target sample label is one of a plurality of sample labels of an input sample, and the target category is one of a plurality of categories in the full data;
training the sub-model through the loss function.

20. The electronic device according to claim 19, wherein before creating a loss function based on classifier output data corresponding to a sub-model in a target sample label and first adjusting data and classifier output data corresponding to the sub-model in a target category and second adjusting data, the method further comprises:
calculating first adjusting data according to a first adjusting function and classifier output data corresponding to the target sample label;
calculating second adjusting data according to a second adjusting function and classifier output data corresponding to the target category;
wherein the first adjusting function and the second adjusting function are the same function.

21. A non-transitory computer-readable storage medium for storing a program that performs a training method for an identification model of a sample data category according to claim 11.

22. An electronic device, comprising one or more processors and a memory for storing one or more programs, which, when executed by the one or more processors, cause the one or more processors to perform a training method for an identification model of a sample data category according to claim 11.
